(19) United States
(12) Patent Application Publication
(10) Pub. No.: US 2026/0002565 A1
(43) Pub. Date: Jan. 1, 2026

(54) BEARING SYSTEMS

(71) Applicant: Schlumberger Technology Corporation, Sugar Land, TX (US)

(72) Inventors: Arthur I. Watson, Lawrence, KS (US); David Milton Eslinger, Bartlesville, OK (US); Pradeep Mahadevan, Singapore (SG)

(21) Appl. No.: 19/249,037

(22) Filed: Jun. 25, 2025

(30) Foreign Application Priority Data
Jul. 1, 2024 (SG) 10202401936Y

(51) Int. Cl. F16C 27/06

(52) U.S. Cl. CPC F16C 27/063

(57) ABSTRACT

A bearing system may include a bearing. A bearing system may include an elastomer ring surrounding the bearing, the elastomer ring contacting the bearing with a ring inner surface, the elastomer ring maintaining a position of the bearing. A bearing system may include a biasing element positioned to apply a biasing force to the elastomer ring, the elastomer ring transferring at least a portion of the biasing force to a radial force on the bearing.

### CROSS-REFERENCE TO RELATED APPLICATIONS

The present application claims the benefit of Singapore Provisional Application No. 10202401936Y filed Jul. 1, 2024, the entirety of which is incorporated by reference herein and should be considered part of this specification.

### BACKGROUND OF THE DISCLOSURE

Bearings are used in many applications to decrease friction and improve the operating lifetime of rotating components. Bearings may be hydrostatic, in which the bearing is a closed system, and the oil may be pressurized from an external source. Some bearings may be hydrodynamic bearings, in which oil is pressurized based on rotation of a journal within the bearing.

Bearings may be used in any mechanical or rotating structure. For example, bearings may be pumps, motors, engines, wheels, and so forth. In one situation, a bearing may be used to support the moving parts of an electric submersible pump (ESP). ESPs may be used to pump fluid out of a wellbore. For example, in an oil and gas wellbore, ESPs may be used to pump water and/or hydrocarbons out of the wellbore. The rotating parts of an ESP may rotate with a high rotational rate, including rates up to and greater than 10,000 rotations per minute (RPM).

### SUMMARY

In some aspects, the techniques described herein relate to a bearing system. The bearing system includes a bearing. An elastomer ring surrounds the bearing. The elastomer ring contacts the bearing with a ring inner surface. The elastomer ring maintains a position of the bearing. A biasing element is positioned to apply a biasing force to the elastomer ring. The elastomer ring transfers at least a portion of the biasing force to a radial force on the bearing.

In some aspects, the techniques described herein relate to a bearing system. The bearing system includes a bearing. An elastomer ring surrounds the bearing. The elastomer ring includes a ring inner surface and a ring outer surface. The elastomer ring contacts the bearing with the ring inner surface. The elastomer ring maintains a position of the bearing. A wire mesh spring is in contact with elastomer ring. The wire mesh spring applies a biasing force to the elastomer ring. The elastomer ring transfers the biasing force to the bearing.

In some aspects, the techniques described herein relate to a method. The method includes connecting an elastomer ring to an outer surface of a bearing. The bearing supports rotation of a journal. A biasing element is secured to the outer surface of the bearing. A longitudinal force is applied to the elastomer ring with the biasing element. The elastomer ring at least partially transfers the longitudinal force to an axial force on the outer surface of the bearing.

This summary is provided to introduce a selection of concepts that are further described in the detailed description. This summary is not intended to identify key or essential features of the claimed subject matter, nor is it intended to be used as an aid in limiting the scope of the claimed subject matter. Additional features and aspects of embodiments of the disclosure will be set forth herein, and in part will be obvious from the description, or may be learned by the practice of such embodiments.

### BRIEF DESCRIPTION OF THE DRAWINGS

In order to describe the manner in which the above-recited and other features of the disclosure can be obtained, a more particular description will be rendered by reference to specific embodiments thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example embodiments, the embodiments will be described and explained with additional specificity and detail through the use of the accompanying drawings in which:

FIG. 1 is a perspective view of a schematic representation of a bearing system 100, according to at least one embodiment of the present disclosure.

FIG. 2 is a longitudinal cross-sectional view of a bearing system, according to at least one embodiment of the present disclosure.

FIG. 3 is a longitudinal cross-sectional view of a bearing system, according to at least one embodiment of the present disclosure.

FIG. 4 is a longitudinal cross-sectional view of a bearing system, according to at least one embodiment of the present disclosure.

FIG. 5 is a longitudinal cross-sectional view of a bearing system, according to at least one embodiment of the present disclosure.

FIG. 6 is a longitudinal cross-sectional view of a bearing system, according to at least one embodiment of the present disclosure.

FIG. 7 is a longitudinal cross-sectional view of a schematic bearing system, according to at least one embodiment of the present disclosure.

FIG. 8 is a flowchart of a method for operating a bearing, according to at least one embodiment of the present disclosure.

### DETAILED DESCRIPTION

This disclosure generally relates to devices, systems, and methods for a mounting system for a bearing. The mounting system may include an elastomer ring surrounding the bearing. The elastomer ring may apply a radial force around the circumference of the outer surface of the bearing to maintain a position of the bearing with respect to a housing and/or protect the bearing from damage due to shock loading in handling, bending during operation, or other damage based on contact of the bearing with other elements of the structure in which the bearing is operated.

In some situations, when subjected to high temperature, an elastomer ring may expand into other areas of the bearing system. For example, the coefficient of thermal expansion for the elastomer ring may be greater than the coefficient of thermal expansion for the bearing, journal, housing, and other metallic or ceramic elements of the bearing system. Put another way, the biasing element may have a lower coefficient of thermal expansion than the elastomer ring. The structure in which the bearing system is used may be subjected to high thermal cycling. For example, ESPs may be subjected to large variations in temperature when used in a drilling environment, based on fluid temperature, formation temperature, and so forth. When subjected to high temperatures, the elastomer ring may expand, and, when space available in the mounting system is filled, flow into other portions of the bearing system. Over one or more thermal cycles, this may cause a permanent deformation in the elastomer ring, resulting in an uneven radial force applied to the bearing, or even a loose connection with the bearing. This may result in the bearing experiencing damage and/or increased wear.

In accordance with at least one embodiment of the present disclosure, a mounting system may include a spring or biasing element that applies a force to constrain the elastomer ring during operation. The compression of the spring allows for a controlled expansion of the elastomer ring during thermal cycling. In this manner, and in accordance with at least one embodiment, the mounting system may reduce or prevent permanent deformation of the elastomer ring based on thermal cycling, thereby extending the operating lifetime of the mounting system.

In some embodiments, the spring may be axially compressible to apply a longitudinal force to the elastomer ring. The elastomer ring may at least partially transfer the longitudinal force to an axial force. During thermal expansion, the elastomer ring may be constrained by the housing to expand longitudinally, the axial compression of the spring may facilitate longitudinal expansion of the elastomer ring without extrusion through gaps in the mounting system, thereby reducing or preventing permanent deformation of the elastomer ring.

In some embodiments, the spring or biasing element may provide damping of shock and vibration for the mounting system. For example, the spring may include a wave spring, and the hysteresis of the wave spring, as well as the compression and interaction of the elements of the wave spring, may absorb at least a portion of the shock and vibration energy. In some examples, the visco-elastic and hysteresis properties of the elastomer ring may provide damping of shock and vibration. In some examples, the spring may include a wire mesh spring, and the interaction of the wires in the wire mesh (including friction between individual wires) may absorb at least a portion of the shock and vibration energy. In some embodiments, friction within the elastomer, wire mesh, and spring systems damp energy in the translation between radial forces and axial forces. Such friction may be provided in multiple ways, including based on the composition of the mounting system. For example, friction may occur between springs and mating elements due to sliding of contact points. In some examples, in wire mesh, friction may occur between wires, or between wires and the elastomer into which it is imbedded, and with adjacent parts. In some examples, friction may occur at an elastomer or wire mesh element with the surfaces against which it slides, including the outer surface of the bearing, the inner surface of the housing, and compression springs or spacers. Such vibration damping may further reduce or prevent damage of the bearing system based on vibrations.

As illustrated by the foregoing discussion, the present disclosure utilizes a variety of terms to describe features and advantages of the bearing system. Additional detail is now provided regarding the meaning of such terms. For example, as used herein, the term “bearing” refers to a stationary element in a bearing system. In particular, the term “bearing” can include an element that is formed integral in a part. A bearing may be formed by a cylindrical bushing inserted into a part. The bearing may be coated with a low-friction coating to facilitate rotation.

As used herein, a “journal” may refer to the rotating element of a bearing. For example, a journal may be a shaft inserted into the bore formed by the inner surface of the cylinder of the bearing. The journal may be connected to one or more rotating parts of a structure. The journal may rotate with a high rotational rate, including up to and over 10,000 RPM.

As used herein, a “biasing element” may include any element that may generate a biasing force. A biasing element may be at least partially elastically deformable or deflectable such that upon compression or deflection of the biasing element to a biased or compressed position, the biasing element may return to the unbiased or uncompressed position with a biasing force. The biasing element may be generally annular or toroidal in shape with an axial or longitudinal deflection or compression. One example of a biasing element includes a spring. The biasing element may include any type of spring, including a wave spring, a coil spring, a wave washer, a Belleville washer, any other spring, and combinations thereof. In some embodiments, the biasing element may include a combination of multiple springs of the same type (e.g., a stack of Belleville washers, a stack of wave springs). In some embodiments, the biasing element may include multiple springs of different types. Stacks of biasing elements may be stacked in parallel (nested), series (crest-to-crest), and combinations thereof. Spiral-wound wave springs may be configured with adjacent turns in series or in parallel. In some embodiments, the biasing force may be applied using any other biasing element, such as fluid pressure, hydraulics, compressed gas (e.g., pneumatics), metal bellows, permanent magnets, electromagnets, weight, a centrifugal force, any other biasing element, and combinations thereof.

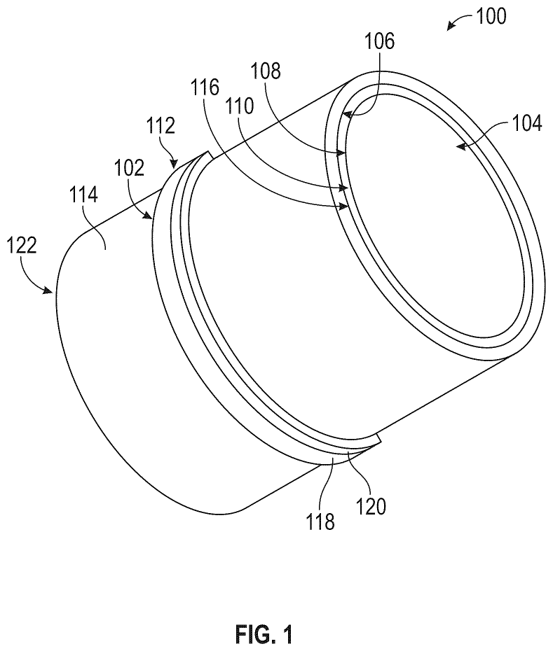

FIG. 1 is a perspective view of a schematic representation of a bearing system 100, according to at least one embodiment of the present disclosure. The bearing system 100 includes a bearing 102 and a journal 104, the bearing 102 supporting rotation of the journal 104. The bearing 102 includes a body 114, the body 114 forming a bore 116 therethrough. The journal 104 is inserted into the bore 116. The bore 116 is defined by an inner surface 106, and the journal 104 has an outer surface 108. An annular space 110 between the inner surface 106 of the bearing 102 and the outer surface 108 of the journal 104 may be filled with oil or grease to facilitate rotation of the journal 104 within the bearing 102.

The bearing system 100 includes a mounting system 112. The mounting system 112 may be used to mount the bearing 102 within a housing. The mounting system 112 may include an elastomer ring 118. The elastomer ring 118 may be connected to both the housing and an outer surface 122 of the bearing 102. The elastomer ring 118 may apply a radially inward elastomer force. The elastomer ring 118 may be secured around an entirety of the outer surface 122 of the bearing 102, and apply an even or approximately even radially inward force to the bearing 102. This may serve to center the bearing 102 within the housing.

As discussed herein, during thermal cycling, the elastomer ring 118 may expand at a greater rate than the surrounding material, including the bearing 102, the journal 104, and the surrounding housing. This may cause the elastomer ring 118 to expand and/or extrude into surrounding areas, which may result in a permanent change in the shape and/or radially inward force applied to the bearing 102.

The mounting system 112 may further include a biasing element 120. The biasing element 120 may apply a longitudinal force on the elastomer ring 118. The elastomer ring 118 may transfer at least a portion of the longitudinal force to the radially inward force. During thermal cycling, the biasing element 120 may compress or deform based on the expansion of the elastomer ring 118, thereby reducing or preventing expansion or extrusion of the elastomer ring 118 into other spaces, resulting in permanent deformation.

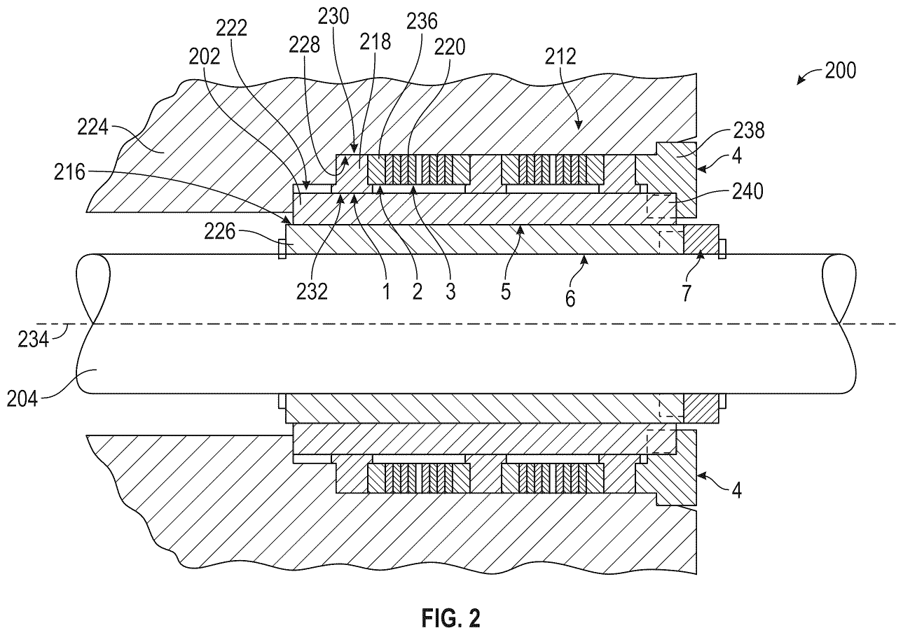

FIG. 2 is a longitudinal cross-sectional view of a bearing system 200, according to at least one embodiment of the present disclosure. The bearing system 200 includes a housing 224 supporting a bearing 202. A journal 204 includes a journal sleeve 226. The bearing 202 supports rotation of the journal 204 within the bearing 202 when the journal sleeve 226 is inserted into a bore 216 of the bearing 202. While embodiments of the present disclosure have been described with respect to mounting the bearing 202 in the housing 224, it should be understood that the techniques of the present disclosure may be applied to the mounting of the journal sleeve 226 on the journal 204.

The bearing system 200 includes a mounting system 212 to mount the bearing 202 to the housing 224. The mounting system 212 may include one or more elastomer rings 218. The housing 224 may include a mounting surface 228. The elastomer ring 218 may include a ring outer surface 230 and a ring inner surface 232. In the embodiment shown, the ring outer surface 230 is in contact with the mounting surface 228, and the ring inner surface 232 is in contact with the outer surface 222 of the bearing 202. In some embodiments, the mounting surface 228 may be coated with a low-friction surface, such as polytetrafluoroethylene (PTFE). This may facilitate sliding of the elements of the mounting system 212 along the mounting surface 228 during thermal cycling, including the elastomer ring 218, the biasing element 220, and the spacer 236.

The elastomer ring 218 may surround the outer surface 222 of the bearing 202 such that the elastomer ring 218 applies a radially inward force to the bearing 202. The radially inward force may be applied toward the center of the bearing 202, or toward the longitudinal axis 234 of the bearing system 200. In some embodiments, the elastomer ring 218 may apply the radially inward force in any manner. For example, the elastomer ring 218 may have an inner diameter at the ring inner surface 232 that is smaller than the outer diameter at the outer surface 222 so that when the elastomer ring 218 is connected to the bearing 202, the elastomer ring 218 may apply a compressive force to the bearing 202. Based on the contact of the ring outer surface 230 with the mounting surface 228, and the contact of the ring inner surface 232 with the outer surface 222, the elastomer ring 218 may center the bearing 202 within the housing 224. In some embodiments, the outer surface 222 of the bearing 202 may be coated with a low-friction surface, such as polytetrafluoroethylene (PTFE). This may facilitate sliding of the elements of the mounting system 212 along the outer surface 222 of the bearing 202 during thermal cycling, including the elastomer ring 218, the biasing element 220, and the spacer 236. In some embodiments, a coating with dielectric properties may be applied to the metallic and other conductive components, such as the biasing element 220 and/or the spacer 236, to prevent electric discharge across the bearing components resulting from shaft currents, commonly known as bearing fluting.

The mounting system 212 may include a biasing element 220. The biasing element 220 may be compressed or deflected to apply a biasing force in the longitudinal direction (e.g., parallel to the longitudinal axis 234). The biasing force of the biasing element 220 may be applied to the elastomer ring 218. The elastomer ring 218 may transfer at least a portion of the biasing force to the bearing 202. This may increase or maintain the radially inward force applied by the elastomer ring 218 to the bearing 202, thereby maintaining the position of the bearing 202 with respect to the housing 224. In some embodiments, the entirety of the radially inward force may be applied based on the transfer of the biasing force through the elastomer ring 218.

The elastomer ring 218 may be any type of elastomer ring. For example, the elastomer ring 218 may have any cross-sectional shape, such as square (e.g., square-rings), rectangular, circular (e.g., O-rings), wedge, semi-circular, trapezoidal, rhomboid, triangular, any other cross-sectional shape, and combinations thereof. In some embodiments, the elastomer ring 218 may include multiple segments formed from discrete elastomer elements. The discrete elastomer elements may have any 3-dimensional shape, including a sphere, axial cylinder, cube, cuboid, wedge, any other 3-dimensional shape, and combinations thereof. The discrete elastomer elements may be arranged in a circular pattern around the bearing 202. In some embodiments, the discrete elastomer elements may be separate parts. In some embodiments, the discrete elastomer elements may be linked together by a thin member, such as a band of elastomer, cord, chain, or wire.

In some embodiments, the elastomer ring 218 includes a solid elastomer material. In some embodiments, the elastomer ring 218 includes a composite material including an elastomer material molded with or adhered to a non-elastomer co-component that acts to enhance its mechanical properties. The co-component may include any material, such as a metal, polymer, organic fiber, non-organic fiber, any other material, and combinations thereof. In some embodiments, the co-component is metal wire or strip embedded in the elastomer element. This may increase the effective modulus of elasticity of the elastomer ring 218, resistance to extrusion, stability of form, and resistance to compression set. In some embodiments, the embedded wire or strip forms a mesh with random orientation of the wire or strip. In some embodiments, the embedded wire or strip has the form of a spring, such as a coil spring encircling the axis, multiple axially oriented coil springs spaced around the circumference, wave springs, washer springs (Belleville washers), any other spring form, and combinations thereof.

The elastomer ring 218 may be at least partially deformable, such that the longitudinal force from the biasing element 220 may cause the elastomer ring 218 to deform and fill the available space without extruding or expanding into the surrounding regions. The elastomer ring 218 may be elastically deformable, such that when the longitudinal force is removed, the elastomer ring 218 may return to its original shape.

The longitudinal force may be transferred to the elastomer ring 218 in any manner. For example, the longitudinal force may be transferred to the elastomer ring 218 via a spacer 236. The spacer 236 may facilitate an even or approximately even distribution of the longitudinal force from the biasing element 220. This may reduce any point loading of the longitudinal force based on the geometry of the biasing element 220. The spacer 236 may be longitudinally slidable within the mounting system 212. In this manner, as the elastomer ring 218 expands and/or the biasing element 220 deflects, the spacer 236 may adjust its longitudinal location accordingly.

The spacer 236 may space the distribution of multiple elastomer rings 218. For example, in the embodiment shown, the mounting system 212 includes three elastomer rings 218 spaced evenly across a length of the bearing 202. The mounting system 212 may include multiple spacers 236 to distribute the elastomer rings 218 across the length of the bearing 202. Using spacer 236 to evenly space multiple elastomer rings 218 may facilitate an even force distribution across the bearing 202.

In the embodiment shown, the mounting system 212 includes two biasing elements 220, spaced between the three elastomer rings 218. This may facilitate a transfer of the biasing force between the elastomer rings and/or facilitate an equalization of the load between multiple elastomer rings 218. While the embodiment of FIG. 2 illustrates three elastomer rings 218 and two biasing elements 220, the disclosure is not so limited. For example, the mounting system 212 may include any number of elastomer rings 218, including 1, 2, 3, 4, 5, 6, 7, 8, 9, 10, or more elastomer rings 218. Further, the mounting system 212 may include any number of biasing elements 220, including 1, 2, 3, 4, 5, 6, 7, 8, 9, 10, or more biasing elements.

The biasing element 220 may be deflectable or compressible in the longitudinal direction. When the elastomer ring 218 expands, the biasing element 220 may deflect based on the expansion. The deflection of the biasing element 220 may provide room for the expansion of the elastomer ring 218. The expansion of the elastomer ring 218 may apply an expansion force against the biasing element 220 that exceeds the biasing force from the biasing element 220, thereby deflecting the biasing element 220. This may allow the elastomer ring 218 to expand within the mounting system 212, thereby preventing extrusion or expansion into smaller spaces. This may reduce or prevent damage to the elastomer ring 218 based on the expansion of the elastomer ring 218.

When the elastomer ring 218 retracts, such as due to a reduction in temperature (including after an expansion due to an increase in temperature), the biasing force from the biasing element 220 may compress the elastomer ring 218 axially to maintain the radially inward force while reducing or preventing loosening of the elastomer ring 218 about the bearing 202.

In accordance with at least one embodiment of the present disclosure, the biasing element 220 may be pre-loaded or pre-compressed. For example, the biasing element 220 may be pre-loaded to generate a desired initial radial load based on the biasing load. Pre-loading the biasing element 220 may further reduce the variability in spring force during thermal expansion by reducing the range of percentage deflection. For example, pre-loaded Belleville washers may have a non-linear load-deflection curve in which the load significantly levels off at higher deflection. In some embodiments, preloading can position the working range of deflection in a more level portion of the load-deflection curve, thereby providing a predictable and even radially inward force by the elastomer ring 218.

The biasing element 220 may be pre-loaded in any manner. For example, the mounting system 212 may include a pre-loading element 238. The pre-loading element 238 may be any type of pre-loading element. For example, the pre-loading element 238 may include a pre-fit ring or other interference-fit ring. The pre-loading element 238 may be threaded into the housing 224. The pre-loading element 238 may include one or more screws or bolts. The pre-loading element 238 may include a retainer ring or snap ring. The position of the pre-loading element 238 may be determined to provide an initial deflection of the biasing element 220 that may provide the pre-loaded biasing force.

In some embodiments, the bearing 202 may be prevented from rotating by an anti-rotation device 240. The anti-rotation device 240 may be any anti-rotation device, such as a ring featuring a lug that engages a recess in the end of the bearing. The anti-rotation device 240 may be fixed to the bearing housing in any manner, such as by press-fit or other interference fit, key, retainer ring, mechanical fastener, any other fixing mechanism, and combinations thereof. In some embodiments, the anti-rotation device 240 includes a pin or key. In some embodiments, the bearing 202 is prevented from rotating by friction with the elastomer ring 218 and/or biasing element 220 that is maintained through thermal cycles by means of spring force, without which the bearing may become lose and spin or deflect excessively. Anti-rotation via friction with the elastomer ring 218 and/or the biasing element 220 may reduce the stress concentrations anti-rotation device 240 and/or reduce the potential of shock loading of the anti-rotation device 240 against the bearing 202.

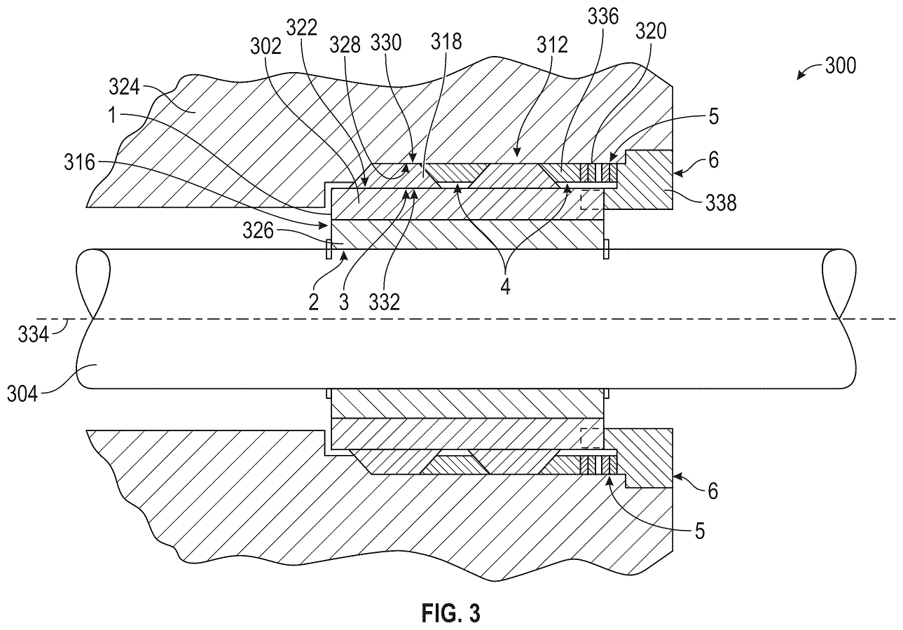

FIG. 3 is a longitudinal cross-sectional view of a bearing system 300, according to at least one embodiment of the present disclosure. The bearing system 300 includes a housing 324 supporting a bearing 302. A journal 304 includes a journal sleeve 326. The bearing 302 supports rotation of the journal 304 within the bearing 302 when the journal sleeve 326 is inserted into a bore 316 of the bearing 302.

The bearing system 300 includes a mounting system 312 to mount the bearing 302 to the housing 324. The mounting system 312 may include one or more elastomer rings 318. The housing 324 may include a mounting surface 328. The elastomer ring 318 may include a ring outer surface 330 and a ring inner surface 332. In the embodiment shown, the ring outer surface 330 is in contact with the mounting surface 328, and the ring inner surface 332 is in contact with the outer surface 322 of the bearing 302.

The mounting system 312 includes a biasing element 320 pre-loaded with a pre-loading element 338 to apply a biasing force to or within the mounting system 312 along or parallel to the longitudinal axis 334. The biasing element 320 may apply the biasing force to one or more spacers 336, which may transfer the biasing force to the elastomer rings in the mounting system 312.

In the embodiment shown, the one or more spacers 336 has a spacer surface 342 that contacts a ring axial surface 344 of the elastomer ring 318. The spacer surface 342 and the ring axial surface 344 may be sloped. For example, the spacer surface 342 may have a sloped surface and the ring axial surface 344 may have a complementary sloped surface. The complementary sloped surfaces may transfer at least a portion of the longitudinal biasing force applied by the biasing element 320 to a radial force applied to the bearing 302 by the mounting system 312. For example, the spacers 336 may act as a wedge against the elastomer ring 318, transferring the longitudinal biasing force to a radial force through the elastomer ring 318. This may facilitate the creation of the radial force mechanically, without relying, or relying less on, on the material properties of the elastomer ring 318 to transfer the longitudinal force to the radial force.

In the embodiment shown, the spacers 336 are not in contact with the bearing 302. In some embodiments, the one or more spacers 336 may be in contact with, or partially in contact with the bearing 302. Reducing or eliminating contact of the one or more spacers 336 with the bearing 302 may reduce or prevent friction with the bearing 302 based on this contact.

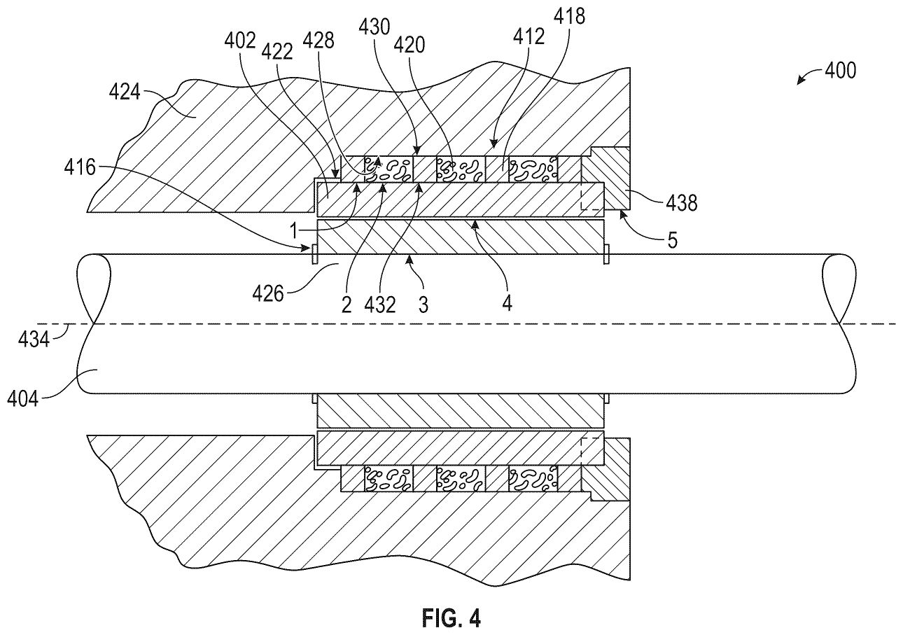

FIG. 4 is a longitudinal cross-sectional view of a bearing system 400, according to at least one embodiment of the present disclosure. The bearing system 400 includes a housing 424 supporting a bearing 402. A journal 404 includes a journal sleeve 426. The bearing 402 supports rotation of the journal 404 within the bearing 402 when the journal sleeve 426 is inserted into a bore 416 of the bearing 402.

The bearing system 400 includes a mounting system 412 to mount the bearing 402 to the housing 424. The mounting system 412 may include one or more elastomer rings 418. The housing 424 may include a mounting surface 428. The elastomer ring 418 may include a ring outer surface 430 and a ring inner surface 432. In the embodiment shown, the ring outer surface 430 is in contact with the mounting surface 428, and the ring inner surface 432 is in contact with the outer surface 422 of the bearing 402.

The mounting system 412 includes a biasing element 420 pre-loaded with a pre-loading element 438 to apply a biasing force to or within the mounting system 412 along or parallel to the longitudinal axis 434. The biasing element 420 may apply the biasing force to one or more elastomer rings 418, which may transfer the biasing force to the elastomer rings in the mounting system 412.

In the embodiment shown, the biasing element 420 includes a wire mesh. The wire mesh biasing element 420 may include a mesh formed from wires. The wire mesh may be any type of wire mesh. For example, the wire mesh may include an ordered arrangement of wires (e.g., a grid, braid, weave, or other ordered arrangement of wires). In some examples, the wire mesh may include a random arrangement of wires. The wire mesh may be compressed into a shape, such as the annular or toroidal shape surrounding the bearing 402, which may provide an effective spring rate upon further compression.

In the embodiment shown, the wire mesh biasing element 420 is in direct contact with the elastomer ring 418. For example, one or more wires from the wire mesh may contact the elastomer ring 418. Direct contact of the wire mesh with the elastomer ring 418 may facilitate damping of shock and vibrations. For example, direct contact of the wire mesh with the elastomer ring 418 may increase friction between the wire mesh and the elastomer ring 418, and the increased friction may absorb at least a portion of the vibratory and/or shock damage. However, it should be understood that this disclosure is not so limited, and the wire mesh biasing element 420 may apply the biasing force to the elastomer ring 418 through a spacer, as discussed herein.

In the embodiment shown, the wire mesh biasing element 420 is in direct contact with the bearing 402. For example, one or more wires from the wire mesh may contact the bearing 402. Direct contact of the wire mesh with the bearing 402 may facilitate damping of shock and vibrations. For example, direct contact of the wire mesh with the elastomer ring 418 may increase friction between the wire mesh and the bearing 402, and the increased friction may absorb at least a portion of the vibratory and/or shock damage. However, it should be understood that this disclosure is not so limited, and the wire mesh biasing element 420 may not be in contact with the bearing 402.

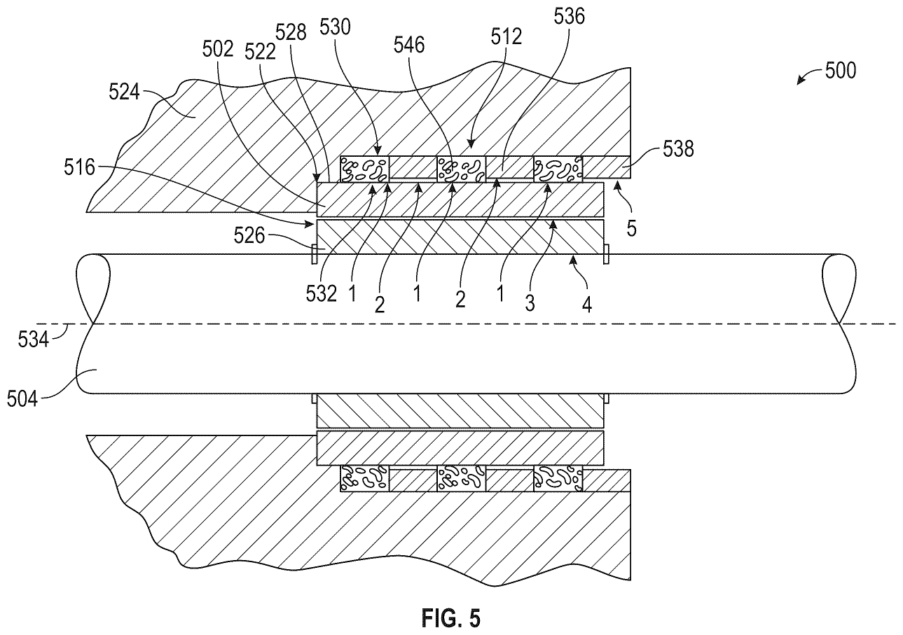

FIG. 5 is a longitudinal cross-sectional view of a bearing system 500, according to at least one embodiment of the present disclosure. The bearing system 500 includes a housing 524 supporting a bearing 502. A journal 504 includes a journal sleeve 526. The bearing 502 supports rotation of the journal 504 within the bearing 502 when the journal sleeve 526 is inserted into a bore 516 of the bearing 502.

The bearing system 500 includes a mounting system 512 to mount the bearing 502 to the housing 524. The mounting system 512 may include wire mesh rings 546. The housing 524 may include a mounting surface 528. The wire mesh rings 546 may include a ring outer surface 530 and a ring inner surface 532. In the embodiment shown, the ring outer surface 530 is in contact with the mounting surface 528, and the ring inner surface 532 is in contact with the outer surface 522 of the bearing 502. The wire mesh rings 546 may be pre-loaded with a pre-loading element 538, such as a press-fit ring, to apply a biasing force to or within the mounting system 512 along or parallel to the longitudinal axis 534.

In the embodiment shown, the wire mesh rings 546 may be formed from a wire mesh, as discussed in further detail herein. The wire mesh rings 546 may provide the radially inward force on the bearing 502. In some embodiments, the pre-loading from the pre-loading element 538 may cause a longitudinal force which may, based on the arrangement of the wire mesh, result or transform into a radial force between housing 524 and the bearing 502. Utilizing the wire mesh rings 546 may simplify the mounting system 512. For example, a wire mesh may provide its own spring force without reliance on separate springs, be resistant to damage based on thermal cycling, have higher temperature limits and operational zones, be chemical resistant, experience reduced creep, stress relaxation, and compression set, and combinations of the previously described benefits.

In some embodiments, the wire mesh rings 546 may operate as a filter to prevent or reduce the ingress of sand or other particulate into the interstitial spaces of the mounting system 512.

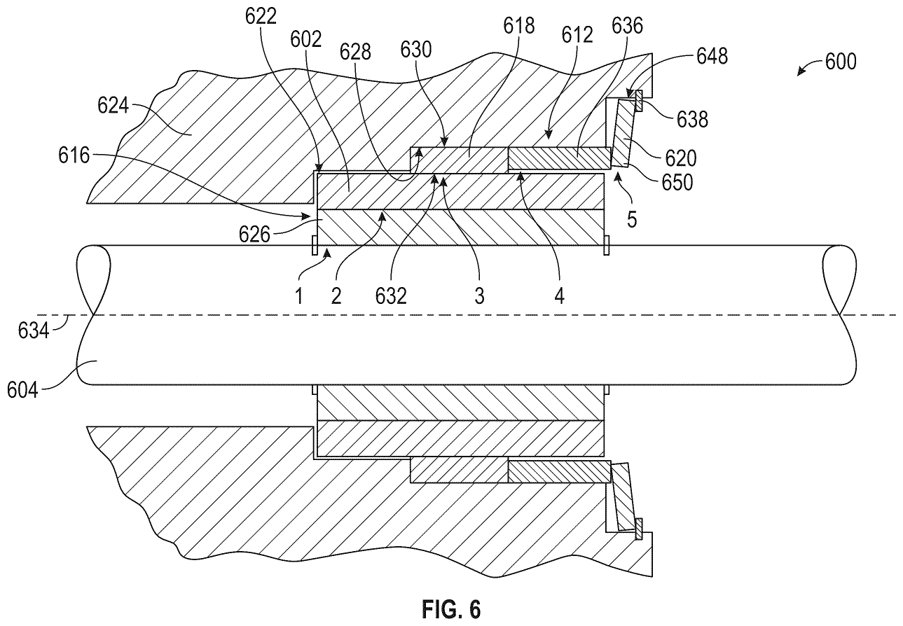

FIG. 6 is a longitudinal cross-sectional view of a bearing system 600, according to at least one embodiment of the present disclosure. The bearing system 600 includes a housing 624 supporting a bearing 602. A journal 604 includes a journal sleeve 626. The bearing 602 supports rotation of the journal 604 within the bearing 602 when the journal sleeve 626 is inserted into a bore 616 of the bearing 602.

The bearing system 600 includes a mounting system 612 to mount the bearing 602 to the housing 624. The mounting system 612 may include one or more elastomer rings 618. The housing 624 may include a mounting surface 628. The elastomer ring 618 may include a ring outer surface 630 and a ring inner surface 632. In the embodiment shown, the ring outer surface 630 is in contact with the mounting surface 628, and the ring inner surface 632 is in contact with the outer surface 622 of the bearing 602.

The mounting system 612 includes a biasing element 620 pre-loaded with a pre-loading element 638 to apply a biasing force to or within the mounting system 612 along or parallel to the longitudinal axis 634. The biasing element 620 may apply the biasing force to one or more spacers 636, which may transfer the biasing force to the elastomer rings in the mounting system 612.

In the embodiment shown, the biasing element 620 is located axially or radially outside the envelope of the bearing 602 and the one or more elastomer rings 618. For example, the biasing element 620 extends past the ring outer surface 630 and the mounting surface 628. Put another way, the biasing element 620 has an outer diameter at an outer end 648 that is greater than the outer diameter at the ring outer surface 630 and the mounting surface 628. An inner end 650 of the biasing element 620 may engage with the one or more spacers 636. Extending the outer end 648 past the mounting surface 628 and the ring outer surface 630 may facilitate the inclusion of a greater length of elastomer elements. This may further reduce the space constraints of the mounting system 612, including space constraints imposed by the design of the spring. This may facilitate greater diameter, length, and range of shapes available for the biasing element 620, including the availability of use of non-circular flat springs. For example, the biasing element 620 may be a Belleville spring of two or three times the radial width of the elastomer elements, providing greater force and deflection in a single spring or stack of springs, and providing greater axial space for more or larger elastomer elements.

In the embodiment shown, the elastomer ring 618 is illustrated as secured to the bearing 602 in the center of the bearing 602. For example, the one or more elastomer rings 618 may be located in the central one third or one fourth of the bearing 602. This may facilitate a reduced angular stiffness relative the axis while maintaining radial stiffness. This may facilitate a slight tilt of the bearing 602 on its axis to accommodate angular misalignment with the shaft. Such misalignment may occur during operation while the ESP is bent. This may reduce or prevent hard edge rub that could spall the bearing 602.

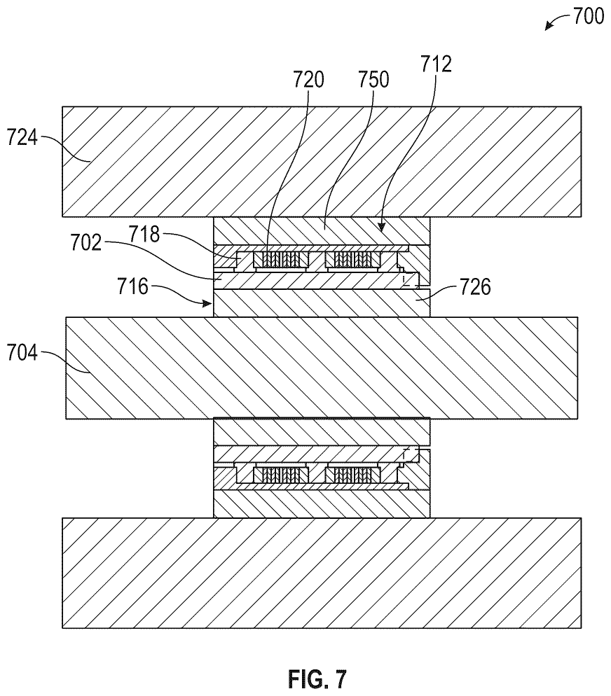

FIG. 7 is a longitudinal cross-sectional view of a schematic bearing system 700, according to at least one embodiment of the present disclosure. The bearing system 700 includes a housing 724 supporting a bearing 702. The bearing 702 supports rotation of a journal 704 within the bearing 702 when the journal 704 is inserted into a bore 716 of the bearing 702.

The bearing system 700 includes a mounting system 712 to mount the bearing 702 to the housing 724. The mounting system 712 may include one or more elastomer rings 718 secured and transferring longitudinal biasing force to radial force by the compression of a biasing element 720, as discussed herein. A journal 704 includes a journal sleeve 726, and the bearing 702 supports rotation of the journal 704 against the journal sleeve 726.

In the embodiment shown, the mounting system 712 is pre-assembled in a carrier 750. For example, the carrier 750 may include any combination of elastomer rings 718, biasing elements 720, spacers, locking elements, and other elements, discussed herein. The carrier 750 may be pre-assembled prior to insertion into the housing 724. This may increase the ease of assembly and/or improve accuracy and/or quality of assembly. Furthermore, pre-assembling the carrier 750 may reduce downtime for installation and/or replacement of the bearing system 700.

Prior to operation, the pre-assembled carrier 750 may be inserted into the housing 724. In some embodiments, the carrier 750 may be inserted into the housing 724 prior to insertion into the journal 704. In some embodiments, the carrier 750 may be inserted into the housing 724 with the journal 704 already inserted into the bore 716.

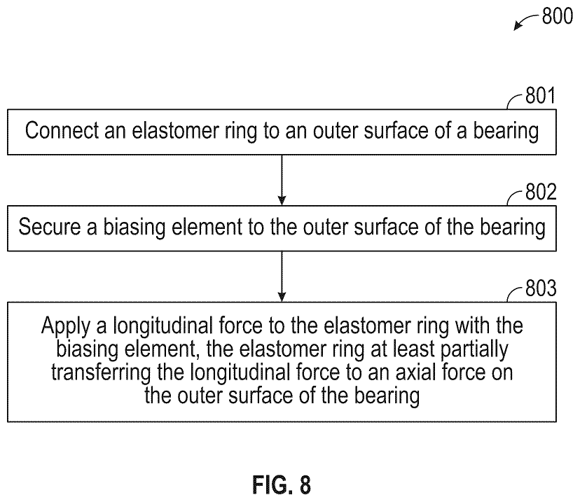

FIG. 8 is a flowchart of a method 800 for operating a bearing, according to at least one embodiment of the present disclosure. An operator may connect an elastomer ring to an outer surface of a bearing at 801. For example, as discussed in further detail herein, the operator may connect the elastomer ring to an entirety of the circumference of the bearing. The elastomer ring may be connected to the bearing in any manner, such as through a mechanical connection, an interference fit, or through constraints via a mounting system. The bearing may support rotation of a journal inserted therein.

A biasing element may be secured to the outer surface of the bearing at 802. For example, an operator may slide the biasing element across the outer surface of the bearing until it is in position and configured to apply the longitudinal biasing force to the elastomer ring. The mounting system may apply a longitudinal force to the elastomer ring with the biasing element at 803. The elastomer ring may at least partially transfer the longitudinal force to an axial force on the outer surface of the bearing.

The embodiments of the bearing system have been primarily described with reference to wellbore drilling operations; the bearing systems described herein may be used in applications other than the drilling of a wellbore. In other embodiments, bearing systems according to the present disclosure may be used outside a wellbore or other downhole environment used for the exploration or production of natural resources. For instance, bearing systems of the present disclosure may be used in a borehole used for placement of utility lines. Accordingly, the terms “wellbore,” “borehole” and the like should not be interpreted to limit tools, systems, assemblies, or methods of the present disclosure to any particular industry, field, or environment.

One or more specific embodiments of the present disclosure are described herein. These described embodiments are examples of the presently disclosed techniques. Additionally, in an effort to provide a concise description of these embodiments, not all features of an actual embodiment may be described in the specification. It should be appreciated that in the development of any such actual implementation, as in any engineering or design project, numerous embodiment-specific decisions will be made to achieve the developers' specific goals, such as compliance with system-related and business-related constraints, which may vary from one embodiment to another. Moreover, it should be appreciated that such a development effort might be complex and time consuming, but would nevertheless be a routine undertaking of design, fabrication, and manufacture for those of ordinary skill having the benefit of this disclosure.

Additionally, it should be understood that references to “one embodiment” or “an embodiment” of the present disclosure are not intended to be interpreted as excluding the existence of additional embodiments that also incorporate the recited features. For example, any element described in relation to an embodiment herein may be combinable with any element of any other embodiment described herein. Numbers, percentages, ratios, or other values stated herein are intended to include that value, and also other values that are “about” or “approximately” the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to embodiments disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the embodiments that falls within the meaning and scope of the claims is to be embraced by the claims.

The terms “approximately,” “about,” and “substantially” as used herein represent an amount close to the stated amount that is within standard manufacturing or process tolerances, or which still performs a desired function or achieves a desired result. For example, the terms “approximately,” “about,” and “substantially” may refer to an amount that is within less than 5% of, within less than 1% of, within less than 0.1% of, and within less than 0.01% of a stated amount. Further, it should be understood that any directions or reference frames in the preceding description are merely relative directions or movements. For example, any references to “up” and “down” or “above” or “below” are merely descriptive of the relative position or movement of the related elements.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A bearing system, comprising:
a bearing;
an elastomer ring surrounding the bearing, the elastomer ring contacting the bearing with a ring inner surface, the elastomer ring maintaining a position of the bearing; and
a biasing element positioned to apply a biasing force to the elastomer ring, the elastomer ring transferring at least a portion of the biasing force to a radial force on the bearing.

2. The bearing system of claim 1, wherein the biasing element includes a wave spring.

3. The bearing system of claim 1, wherein the biasing element includes a Belleville washer.

4. The bearing system of claim 1, wherein the biasing element includes a wire mesh spring.

5. The bearing system of claim 1, wherein the elastomer ring transfers the portion of the biasing force to the radial force based on visco-elastic and hysteresis properties of the elastomer ring.

6. The bearing system of claim 1, further comprising a pre-loading adjacent to the biasing element to pre-load the biasing element.

7. The bearing system of claim 1, further comprising a spacer between the biasing element and the elastomer ring.

8. The bearing system of claim 1, wherein the elastomer ring includes a sloped surface, and further comprising a spacer in contact with the elastomer ring at the sloped surface, wherein the biasing element is in contact with the spacer such that the biasing force is transferred to the elastomer ring through contact between the spacer and the sloped surface.

9. The bearing system of claim 8, wherein the spacer is longitudinally slidable along a length of the bearing.

10. The bearing system of claim 1, wherein the biasing element has an outer end that extends past an outer diameter of the elastomer ring.

11. The bearing system of claim 1, wherein the biasing element has a lower coefficient of thermal expansion than the elastomer ring.

12. The bearing system of claim 1, wherein the biasing element deflects along a longitudinal axis of the bearing.

13. A bearing system, comprising:
a bearing;
an elastomer ring surrounding the bearing, the elastomer ring including a ring inner surface and a ring outer surface, the elastomer ring contacting the bearing with the ring inner surface, the elastomer ring maintaining a position of the bearing; and
a wire mesh spring in contact with elastomer ring, the wire mesh spring applying a biasing force to the elastomer ring, the elastomer ring transferring the biasing force to the bearing.

14. The bearing system of claim 13, wherein the wire mesh spring surrounds the bearing such that the biasing force is approximately even across the elastomer ring.

15. The bearing system of claim 13, further comprising a pre-loading element to pre-load the wire mesh spring.

16. The bearing system of claim 13, further comprising a spacer between the wire mesh spring and the elastomer ring.

17. The bearing system of claim 13, wherein the wire mesh spring extends across an entirety of a length of the elastomer ring.

18. A method, comprising:
connecting an elastomer ring to an outer surface of a bearing, the bearing supporting rotation of a journal;
securing a biasing element to the outer surface of the bearing; and
applying a longitudinal force to the elastomer ring with the biasing element, the elastomer ring at least partially transferring the longitudinal force to an axial force on the outer surface of the bearing.

19. The method of claim 18, further comprising pre-loading the biasing element to apply the longitudinal force to the elastomer ring.

20. The method of claim 19, wherein pre-loading the biasing element includes mechanically pre-loading the biasing element with a pre-loading element.
